(19) United States
(12) Patent Application Publication
(10) Pub. No.: US 2026/0093808 A1
(43) Pub. Date: Apr. 2, 2026

(54) Hardware Mitigation of Cache Side-Channel Attacks

(71) Applicant: Advanced Micro Devices, Inc., Santa Clara, CA (US)

(72) Inventor: William Louie Walker, Fort Collins, CO (US)

(73) Assignee: Advanced Micro Devices, Inc., Santa Clara, CA (US)

(21) Appl. No.: 18/902,707

(22) Filed: Sep. 30, 2024

(51) Int. Cl. G06F 21/55; G06F 12/14; G06F 21/54

(52) U.S. Cl. CPC G06F 21/556; G06F 12/1458; G06F 21/54

(57) ABSTRACT

Systems and techniques for hardware mitigation of cache side-channel attacks are described. In one example, a processor includes a cache system having a shared cache level of a hierarchy of cache levels and cache controller circuitry associated with the shared cache level. The cache controller circuitry monitors access requests of each application or thread accessing the shared cache level. In response to detecting a suspicious access pattern indicative of a cache side-channel attack by a particular application, the cache controller circuitry penalizes subsequent access requests by the application. The described techniques increase the noise and complexity of cache side-channel attacks without penalizing the latency of access requests of potential victims and other applications accessing a shared cache level.

### BACKGROUND

Processors utilize cache memory to store frequently accessed data for quicker retrieval. Accessing data in a cache typically triggers changes to the cache’s internal state, leading to increased access speed for recently accessed data. By monitoring cache access patterns, such as access timing and hit/miss ratios, during a victim application’s operation, a malicious attacker sharing a cache with the victim application can deduce information about the application’s sensitive or secret data. While cache side-channel attacks are challenging, evolving techniques allow attackers to extract information from brief colocation time windows.

### BRIEF DESCRIPTION OF THE DRAWINGS

FIG. 1 is a block diagram of a non-limiting example system to implement hardware mitigation of cache side-channel attacks.

FIG. 2 depicts a non-limiting example in which hardware mitigation techniques are implemented to mitigate cache side-channel attacks.

FIG. 3 depicts a procedure in an example implementation of hardware mitigation of cache side-channel attacks.

FIG. 4 depicts a block diagram of a processing system configured to execute one or more applications in accordance with one or more implementations.

### DETAILED DESCRIPTION

### Overview

An example system includes a processor communicatively coupled to a memory system with volatile and non-volatile memory. The processor includes a cache system with multiple cache levels. For example, the cache system includes level one caches and level two caches dedicated to the respective cores of the processor. A last level or level-three cache is also shared among the multiple cores or applications.

Cache side-channel attacks are security breaches in which a malicious application (e.g., an attacker) arranges to be collocated in a server or other computer environment with a victim. In these scenarios, the attacker and victim share a cache, such as a last level or level three cache. The attacker tries to discern the victim’s sensitive or secret data by analyzing cache hit/miss behavior at a specific location in the shared cache. One type of cache side-channel attack is a “prime+probe” attack, which takes advantage of the fact that accessing recently used cache lines is generally faster. The attacker removes the victim’s cache lines from a target index and then watches that index using its own hit/miss behavior to determine if the victim restores a line to that index. Although this attack is challenging in the noisy environment of a shared cache, the technology is advancing, allowing attackers to obtain accurate information from a victim even in short colocation time windows.

One conventional technique to prevent cache side-channel attacks is to create and assign hardware-isolated cache partitions or slices so an attacker cannot observe or penalize a victim’s hit/miss behavior. Such partitioning does not scale well, especially as the number of cores and applications sharing last level caches increases.

Another conventional technique involves introducing random timing in the shared cache. In this approach, a cache controller deliberately varies the response time of all data traffic to increase the noise. By increasing the randomization, the controller attempts to extend the computation time beyond the duration of colocation windows. However, this approach leads to longer access times for each core or thread, including potential victims, resulting in higher latency and decreased computation rates.

In contrast, this document describes techniques for hardware to counteract behavior indicative of an ongoing cache side-channel attack. When such behavior is detected, the hardware impairs the attacker’s caching privileges, significantly increasing the difficulty for the attacker to monitor or manipulate a victim’s cache hit/miss results. This makes cache side-channel attacks prohibitively expensive but does not impact access times for potential victims and other threads accessing the shared cache.

In some aspects, the techniques described herein relate to a processor comprising a cache controller associated with a shared cache level of a hierarchy of one or more cache levels, the cache controller is configured to penalize access requests from a first application to the shared cache level in response to detecting a suspicious access pattern of the access requests, the shared cache level accessible by multiple applications of the processor, including the first application and a second application.

In some aspects, the techniques described herein relate to a processor wherein the suspicious access pattern indicates a cache side-channel attack by the first application against the second application.

In some aspects, the techniques described herein relate to a processor wherein the suspicious access pattern includes a number of access requests by the first application to a cache index of multiple cache indices in the shared cache level within a time window, the number being greater than or equal to an access threshold.

In some aspects, the techniques described herein relate to a processor wherein the time window is a sliding time window.

In some aspects, the techniques described herein relate to a processor wherein the cache controller is further configured to obtain statistics on the access requests of each application having access to the shared cache level.

In some aspects, the techniques described herein relate to a processor wherein the cache controller is configured to penalize the access requests by sending subsequent access requests of the first application to memory located outside the hierarchy of one or more cache levels.

In some aspects, the techniques described herein relate to a processor wherein the cache controller is configured to penalize the access requests by introducing a delay in responses to subsequent access requests of the first application.

In some aspects, the techniques described herein relate to a processor wherein the delay is a variable and random amount for each response to the subsequent access requests of the first application.

In some aspects, the techniques described herein relate to a processor wherein the cache controller is configured to penalize the access requests for a set amount of time.

In some aspects, the techniques described herein relate to a processor wherein the set amount of time depends on a degree, a length, or a repetition of the suspicious access pattern by the first application or is longer than a colocation window for the first application and the second application in the shared cache level..

In some aspects, the techniques described herein relate to a processor wherein the cache controller is configured to penalize the access requests by temporarily partitioning a cache line of the shared cache level targeted by the access requests from other cache lines accessed by the second application.

In some aspects, the techniques described herein relate to a processor wherein the processor comprises a system on chip (SoC) with multiple processing cores.

In some aspects, the techniques described herein relate to a system comprising: multiple processor cores, including a first application executing on a first processor core and a second application executing on a second processor core, a shared cache level of a hierarchy of one or more cache levels accessible by the multiple processor cores, and a cache controller associated with the shared cache level configured to penalize first access requests from the first application to the shared cache level in response to detecting a suspicious access pattern of the first access requests in relation to second access requests of the second application.

In some aspects, the techniques described herein relate to a system wherein the first application and the second application have access to the shared cache level for a first amount of time.

In some aspects, the techniques described herein relate to a system wherein the cache controller is configured to penalize the first access requests for a second amount of time, the second amount of time being equal to or greater than the first amount of time.

In some aspects, the techniques described herein relate to a system wherein the cache controller is further configured to maintain a record of suspicious access patterns by the first application.

In some aspects, the techniques described herein relate to a system wherein the cache controller is configured to penalize the first access requests by sending subsequent first access requests of the first application to memory located outside the hierarchy of one or more cache levels or introducing a delay in responses to the subsequent first access requests of the first application.

In some aspects, the techniques described herein relate to a system wherein the shared cache level is a level three cache.

In some aspects, the techniques described herein relate to a system wherein the suspicious access pattern includes a number of first access requests by the first application to a cache index of multiple cache indices in the shared cache level within a time window, the number being greater than or equal to an access threshold.

In some aspects, the techniques described herein relate to a method comprising: monitoring, by a cache controller, access requests of an application of multiple applications to a shared cache level of a hierarchy of one or more cache levels; and in response to detecting a suspicious access pattern of the access requests, penalizing, by the cache controller, subsequent access requests from the application to the shared cache level.

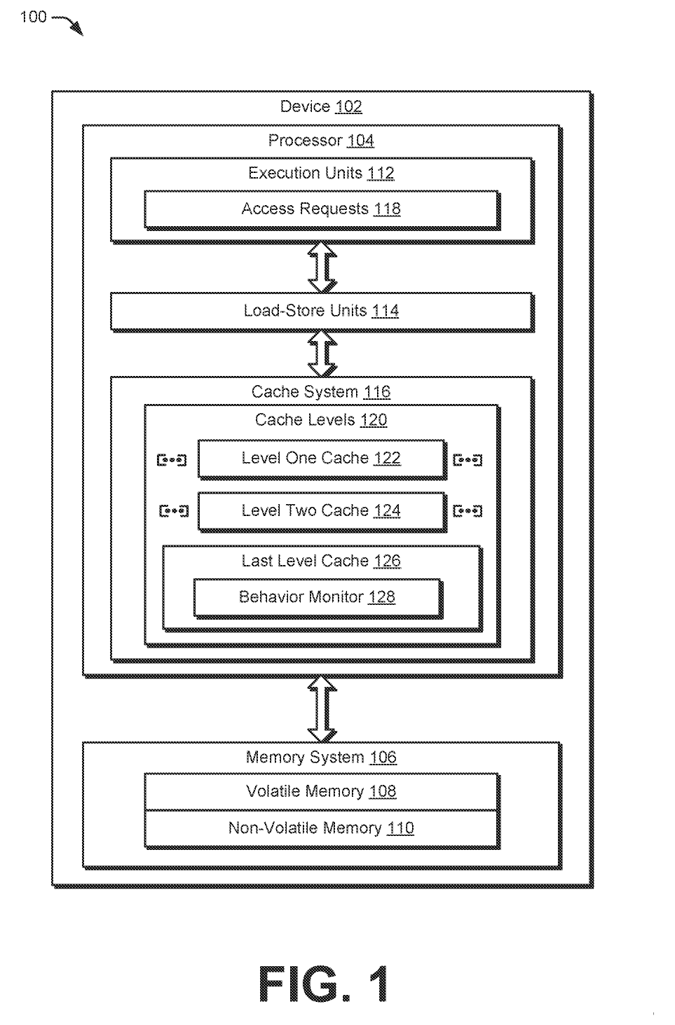

FIG. 1 is a block diagram of a non-limiting example system 100 to implement hardware mitigation techniques for cache side-channel attacks. The system 100 includes a device 102 having a processor 104 and a memory system 106 having volatile memory 108 and non-volatile memory 110. The device 102 is configurable in a variety of ways. Examples of the device 102 include, by way of example and not limitation, computing devices, servers, mobile devices (e.g., wearables, mobile phones, tablets, laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations. It is to be appreciated that in various implementations, the device 102 is configured as any one or more of those devices listed just above and/or a variety of other devices without departing from the spirit or scope of the described techniques.

In accordance with the described techniques, the processor 104 and the memory system 106 are coupled to one another via one or more wired and/or wireless connections. Example wired connections include, but are not limited to, buses (e.g., a data bus), interconnects, traces, and planes. The processor 104 is an electronic circuit that reads, translates, and executes workloads of a program, e.g., an application, operating system, virtual machine, container, and so on. Examples of processor 104 include, but are not limited to, central processing units (CPUs), graphics processing units (GPUs), Field Programmable Gate Arrays (FPGAs), Application Specific Integrated Circuits (ASICs), digital signal processors (DSPs), systems on chip (SoCs), and accelerator devices.

The volatile memory 108 and the non-volatile memory 110 are devices and/or systems used to store information, such as for use by the processor 104. By way of example, the processor 104 includes a memory module (e.g., a Transflash memory module, a single in-line memory module (SIMM), or a dual in-line memory module (DIMM)), and the memory module is a circuit board (e.g., a printed circuit board) on which the volatile memory 108 and the non-volatile memory 110 are mounted. Further, the volatile memory 108 and the non-volatile memory 110 correspond to semiconductor memory, where data is stored within memory cells on one or more integrated circuits.

Broadly, the volatile memory 108 retains data as long as the device 102 is connected to power, and the data is accessible relatively faster than the non-volatile memory 110. Examples of volatile memory 108 include random-access memory (RAM), dynamic random-access memory (DRAM), synchronous dynamic random-access memory (SDRAM), and static random-access memory (SRAM).

The non-volatile memory 110 retains data even after the device 102 is disconnected from power, but is accessible relatively slower than the volatile memory 108. Examples of non-volatile memory include solid state disks (SSD), flash memory, read-only memory (ROM), programmable read-only memory (PROM), erasable programmable read-only memory (EPROM), and electronically erasable programmable read-only memory (EEPROM).

As shown, the processor 104 includes one or more execution units 112, one or more load-store units 114, and a cache system 116 coupled to one another via one or more wired and/or wireless connections. An execution unit 112 is representative of functionality implemented in hardware (e.g., electronic circuitry) of the processor 104 to perform specific types of workloads, such as arithmetic and logic operations. Further, a load-store unit 114 is representative of functionality implemented in the hardware of the processor 104 to perform load operations and store operations as part of a workload. The execution units 112 and the load-store units 114 perform respective operations based on requests received through the execution of software programs, e.g., applications, operating systems, virtual machines, containers, and so on. By way of example, requests are generated and forwarded to the execution units 112 and/or the load-store units 114 by a control unit (not depicted) of the processor 104.

Load requests instruct the load-store units 114 to load data from the cache system 116, the volatile memory 108, and/or the non-volatile memory 110 into registers of the execution units 112. Once loaded into registers, requests (e.g., arithmetic and logic requests) are executable by the execution units 112 to perform corresponding operations (e.g., arithmetic and logic operations) on the data. Store requests instruct the load-store units 114 to store data from the registers (e.g., after the data has been processed by the execution units 112) in the cache system 116, the volatile memory 108, and/or the non-volatile memory 110. Load requests and store requests issued by the load-store units 114 as part of executing a runtime program are referred to herein collectively as “access requests 118.”

As illustrated, the cache system 116 includes a hierarchy of multiple cache levels 120, including a level one cache 122, a level two cache 124, and a last level cache 126, also called a level three (L3) cache or a shared cache level. By way of example, processor 104 is a multi-core processor, and each respective core includes the level one cache 122 and level two cache 124 that are exclusively used by the respective core. Furthermore, the processor 104 includes the last level cache 126, which is shared among the multiple cores.

The cache system 116 corresponds to semiconductor memory where data is stored within memory cells on one or more integrated circuits. The higher cache levels (e.g., level one cache 122) are accessible (e.g., for loading and/or storing data) relatively faster than the lower cache levels (e.g., the last level cache 126). Lower cache levels in the hierarchy of cache levels generally have greater memory capacity than higher cache levels. In other implementations, the cache system 116 includes differing numbers of cache levels and different hierarchical structures without departing from the spirit or scope of the described techniques. For example, a different level cache or multiple level caches are shared among the multiple cores of the processor 104 in another implementation.

The cache system 116 is accessible (e.g., for loading and/or storing data in response to the access requests 118) relatively faster than the memory system 106, which is located outside the hierarchy of the cache system 116. The various memory sources of processor 104 are ordered from fastest access speed to slowest access speed in the following order: (1) the level one cache 122, (2) the level two cache 124, (3) the last level cache 126, (4) the volatile memory 108, and (5) the non-volatile memory 110. As a result, a load-store unit 114 executes a load request that includes a memory address by progressively checking the memory sources for the identified data in the aforementioned order. If the data is present in a memory source, the load-store unit 114 loads the data from that memory source into the registers, and if not, the load-store unit 114 proceeds to check whether the data is present in the next memory source.

As illustrated in FIG. 1, the last level cache 126 includes a behavior monitor 128, which is representative of functionality implemented in the hardware of the cache system 116 to monitor the access requests 118 to identify and mitigate behavior indicative of a cache side-channel attack by an application, thread, or client of an execution unit 112. In one implementation, the behavior monitor 128 is integrated into a cache controller associated with the last level cache 126 and/or the cache system 116. For example, behavior monitor 128 is electronic circuitry and/or logic that monitors memory access patterns of each workload and identifies potential cache side-channel attacks based on access requests 118. The cache controller is electronic circuitry that manages the access requests 118 and maintains data consistency between the memory system 106 and the cache system 116 (or a level thereof).

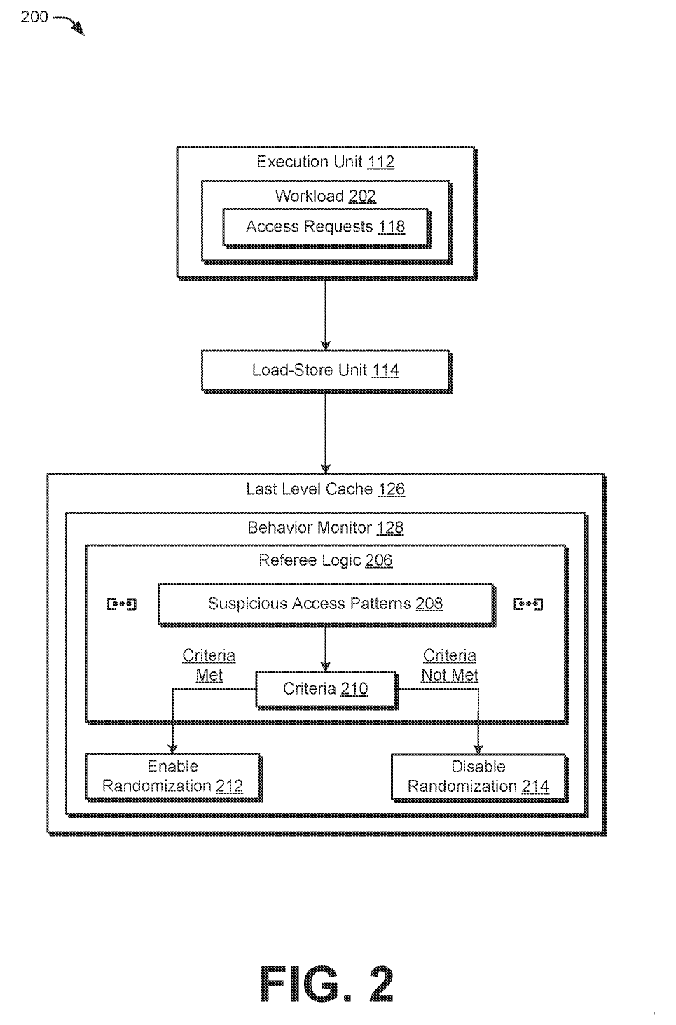

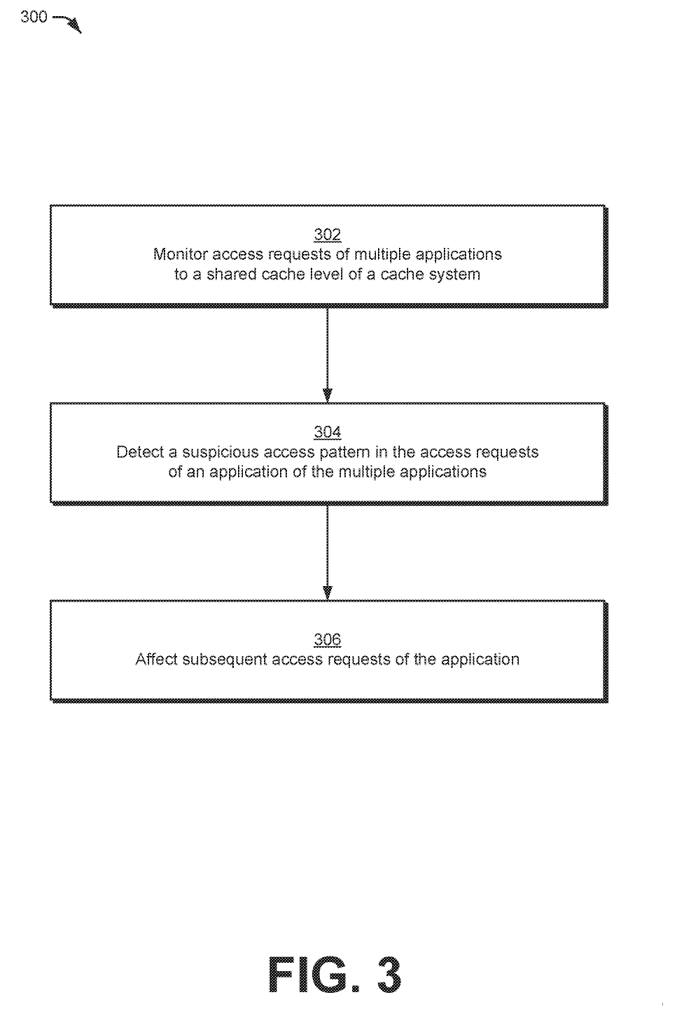

Specifically, the behavior monitor 128 gathers statistics on recent traffic from each workload or client thread sharing the last level cache 126. In response to identifying a potential side-channel attack or suspicious access pattern (e.g., a particular workload makes repeated requests to the same cache index in a small time window), the behavior monitor 128 then impairs or otherwise penalizes the attacking workload’s caching privileges to the last level cache 126 to significantly increase the difficulty for the attacking workload to observe or penalize the victim workload’s cache hit/miss results. Additional details and operations of the behavior monitor 128 are described in relation to FIGS. 2 and 3.

FIG. 2 depicts a non-limiting example 200 in which hardware mitigation techniques are implemented to mitigate cache side-channel attacks. As shown, the example 200 includes an execution unit 112, a load-store unit 114, a last level cache 126, and the behavior monitor 128 of FIG. 1.

In accordance with the described techniques, the execution unit 112 processes a workload 202, which includes access requests 118 to the last level cache 126. The workload 202 includes, for example, an application, client, or thread of the execution unit 112. The access requests 118 include requests issued by the load-store units 114 that access the last level cache 126.

The behavior monitor 128 gathers statistics on recent access traffic from each workload 202 sharing the last level cache 126. In particular, the behavior monitor 128 includes referee logic 206 configured to monitor the access requests 118 to identify suspicious access patterns 208 in the accessed memory addresses or indices. A suspicious access pattern 208 refers to access requests 118 indicative of a cache side-channel attack. For example, one suspicious access pattern 208 includes a sequence of requests from a particular workload 202 to the same cache index (or cache line specifying the row where particular data is stored) within a small time window. The number of requests and the time window are configurable to adapt to the evolving nature of malicious attacks. In addition, the time window is successive or dynamic (e.g., a sliding window). Parameter values for the number of requests and the time window’s duration (and type) are stored as criteria 210. For example, the criteria 210 includes an access threshold that indicates a limit of the number of access requests by the same workload 202 to a particular index in the last level cache 126.

Once the criteria 210 is set, the referee logic 206 compares the latest access requests 118 for each workload 202 to determine whether to randomize or otherwise penalize the responses of the attacking workload. If the access requests 118 satisfy the criteria 210 (i.e., “criteria met” in the illustrated example 200), the referee logic 206 randomizes responses to access requests 118 for workload 202 (i.e., enable randomization 212). If, however, the access requests do not satisfy the criteria 210 (i.e., “criteria not met” in the illustrated example 200), the referee logic 206 disables or stops randomizing the responses to access requests 118, i.e., disable randomization 214. In one implementation, the behavior monitor 128 keeps a log or record of the suspicious access patterns 208 by each workload 202.

When randomization is enabled, the referee logic 206 continues to randomize access requests 118 from workload 202 until the criteria are no longer satisfied. In another implementation, the randomization is disabled or stopped for a particular workload 202 after a set time has expired. In one implementation, the randomization period progressively increases based on the length or degree (e.g., the number of probes to the same index) of the suspicious access pattern 208 or repeated detections of suspicious access patterns 208 by the same workload 202. In another implementation, the set time period is longer than a colocation window for the attacking workload 202 and the victim workload 202 in the last level cache 126. For example, some computing environments include many workloads 202 with multiple last level caches 126. Subsets of these workloads 202 share a particular last level cache 126 of the multiple last level caches 126. In some implementations, collocating the subset of workloads 202 to the same last level cache 126 is periodically changed. Accordingly, the set time period for the randomization may be equal to or longer than the collocation period. In other implementations, the randomization is disabled upon the ending of the current collocation period.

As described above, the randomization includes sending access requests 118 from the attacking workload 202 to the memory system 106 (e.g., bypassing the last level cache 126) or arbitrary delays for responses to subsequent access requests 118 of the attacking workload 202. The introduced delays are generally a variable and random amount of time for each response to introduce greater noise in the attacking workload’s observation of cache activity. In this way, the attacking workload 202 can no longer force the eviction of a victim’s data from the last level cache 126 or accurately observe when that data is restored to the last level cache 126. As a result, cache side-channel attacks become prohibitively expensive for the attacking workload 202.

In another implementation, the randomization includes creating a temporary partition at the targeted index(es) or cache lines in the last level cache 126. In this way, the caches lines of the attacking workload 202 are isolated from the cache lines of the other workloads, including the victim workload. The partition is activated by the hardware of the behavior monitor 128 without requiring software to define numerous partitions and assign the applications thereto.

FIG. 3 depicts a procedure 300 in an example implementation of hardware mitigation of cache side-channel attacks. In the procedure 300, access requests of multiple applications (or threads) to a shared cache level of a cache system are monitored (block 302). By way of example, the behavior monitor 128 monitors access requests 118 of multiple workloads 202 to the last level cache 126.

A behavior monitor or cache controller associated with the shared cache level detects a suspicious access pattern in the access requests of a particular application of the multiple applications (block 304). For example, the behavior monitor 128 uses the referee logic 206 to identify the suspicious access pattern 208 of an attacking workload. As described above, the suspicious access pattern 208 includes repeated requests to a particular cache index within a set time window. The referee logic 206 uses criteria 210 to determine whether the access requests 118 for the attacking workload 202 qualifies as a suspicious access pattern 208.

In response to detecting the suspicious access pattern, the behavior monitor or cache controller penalizes subsequent access requests of the particular application (block 306). For example, the behavior monitor 128 causes the access requests 118 of the attacking workload to be sent to the memory system 106 or responses thereto to be delayed by varied and random amounts to introduce greater noise in the observable behavior of the last level cache 126.

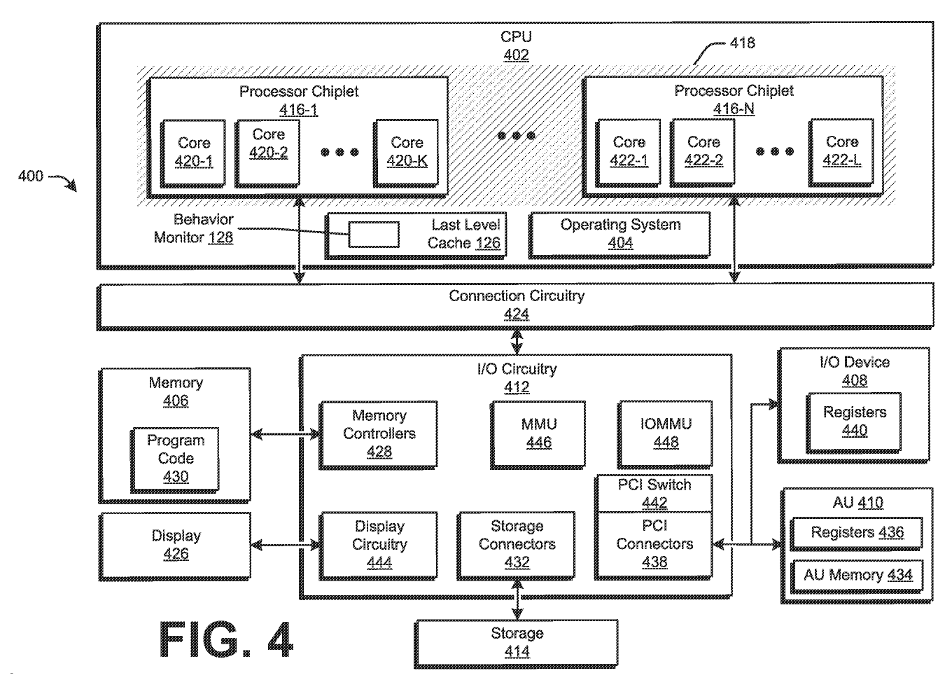

FIG. 4 is a block diagram of a processing system configured to execute one or more applications in accordance with one or more implementations.

In particular, FIG. 4 includes a processing system 400 configured to execute one or more applications, such as computing applications (e.g., machine-learning applications, neural network applications, high-performance computing applications, databasing applications, gaming applications), graphics applications, and the like. Examples of devices in which the processing system 400 is implemented include but are not limited to a server computer, personal computer (e.g., desktop or tower computer), smartphone or another wireless phone, tablet or phablet computer, notebook computer, laptop computer, wearable device (e.g., smartwatch, augmented reality headset or device, virtual reality headset or device), entertainment device (e.g., gaming console, portable gaming device, streaming media player, digital video recorder, music or another audio playback device, television, set-top box), Internet of Things (IoT) device, automotive computer or computer for another type of vehicle, networking device, medical device or system, and other computing devices or systems.

In the illustrated example, the processing system 400 includes a central processing unit (CPU) 402. In one or more implementations, the CPU 402 is configured to run an operating system (OS) 404 that manages the execution of applications. For example, the OS 404 is configured to schedule the execution of tasks (e.g., instructions) for applications, allocate portions of resources (e.g., system memory 406, CPU 402, input/output (I/O) device 408, accelerator unit (AU) 410, storage 414) for the execution of tasks for the applications, provide an interface to I/O devices (e.g., I/O device 408) for the applications, or any combination thereof.

The CPU 402 includes one or more processor chiplets 416, which are communicatively coupled by a data fabric 418 in one or more implementations. Each processor chiplet 416, for example, includes one or more processor cores 420, 422 configured to execute one or more series of instructions concurrently, also referred to herein as “threads” or workloads 202, for an application. Further, the data fabric 418 communicatively couples each processor chiplet 416-N of the CPU 402 such that each processor core (e.g., processor cores 420) of a first processor chiplet (e.g., 416-1) is communicatively coupled to each processor core (e.g., processor cores 422) of one or more other processor chiplets 416.

Though the example embodiment in FIG. 4 shows a first processor chiplet (416-1) having three processor cores (420-1, 420-2, 420-K) representing a K number of processor cores 422 and a second processor chiplet (416-N) having three processor cores (e.g., 422-1, 422-2, 422-L) representing an L number of processor cores 422, in other implementations (L being an integer number greater than or equal to one), each processor chiplet 416 may have any number of processor cores 420, 422. For example, each processor chiplet 416 can have the same number of processor cores 420, 422 as one or more other processor chiplets 416, a different number of processor cores 420, 422 as one or more other processor chiplets 416, or both.

In this example, the last level cache 126 is depicted in the CPU 402 and is configured to be shared by the processor cores 420 and the processor cores 422. In variations, however, the last level cache 126 is included in the processor chiplets 416 to be shared by the corresponding processor cores 420. The last level cache 126 also includes the behavior monitor 128. In at least one implementation, the last level cache 126 with the behavior monitor 128 is included in at least two of the depicted components of the processing system 400 (e.g., each processor chiplet 416).

Examples of connections that are usable to implement the data fabric 418 include but are not limited to buses (e.g., a data bus, a system, an address bus), interconnects, memory channels, and silicon vias, traces, and planes. Other example connections include optical connections, fiber optic connections, and/or connections or links based on quantum entanglement.

Additionally, within the processing system 400, the CPU 402 is communicatively coupled to an I/O circuitry 412 by a connection circuitry 424. For example, each processor chiplet 416 of the CPU 402 is communicatively coupled to the I/O circuitry 412 by the connection circuitry 424. The connection circuitry 424 includes, for example, one or more data fabrics, buses, buffers, queues, and the like. The I/O circuitry 412 is configured to facilitate communications between two or more components of the processing system 400 such as between the CPU 402, system memory 406, display 426, universal serial bus (USB) devices, peripheral component interconnect (PCI) devices (e.g., I/O device 408, AU 410), storage 414, and the like.

As an example, system memory 406 includes any combination of one or more volatile memories and/or one or more non-volatile memories, examples of which include dynamic random-access memory (DRAM), static random-access memory (SRAM), non-volatile RAM, and the like. To manage access to the system memory 406 by CPU 402, the I/O device 408, the AU 410, and/or any other components, the I/O circuitry 412 includes one or more memory controllers 428. The memory controllers 428, for example, include circuitry configured to manage and fulfill memory access requests issued from the CPU 402, the I/O device 408, the AU 410, or any combination thereof. Examples of such requests include read requests, write requests, fetch requests, pre-fetch requests, or any combination thereof. That is to say, the memory controllers 428 are configured to manage access to the data stored at one or more memory addresses within the system memory 406, such as by CPU 402, I/O device 408, and/or AU 410.

When an application is to be executed by processing system 400, the OS 404 running on the CPU 402 is configured to load at least a portion of program code 430 (e.g., an executable file) associated with the application from, for example, a storage 414 into system memory 406. This storage 414, for example, includes a non-volatile storage such as a flash memory, solid-state memory, hard disk, optical disc, or the like configured to store program code 430 for one or more applications.

To facilitate communication between the storage 414 and other components of processing system 400, the I/O circuitry 412 includes one or more storage connectors 432 (e.g., universal serial bus (USB) connectors, serial AT attachment (SATA) connectors, PCI Express (PCIe) connectors) configured to communicatively couple storage 414 to the I/O circuitry 412 such that I/O circuitry 412 is capable of routing signals to and from the storage 414 to one or more other components of the processing system 400.

In association with executing an application, in one or more scenarios, the CPU 402 is configured to issue one or more instructions (e.g., threads) to be executed for an application to the AU 410. The AU 410 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 410 includes one or more compute units that concurrently execute one or more threads of an application and store data resulting from the execution of these threads in AU memory 434. This AU memory 434, for example, includes any combination of one or more volatile memories and/or non-volatile memories, examples of which include caches, video RAM (VRAM), or the like. In one or more implementations, these compute units are also configured to execute these threads based on the data stored in one or more physical registers 436 of the AU 410.

To facilitate communication between the AU 410 and one or more other components of processing system 400, the I/O circuitry 412 includes or is otherwise connected to one or more connectors, such as PCI connectors 438 (e.g., PCIe connectors) each including circuitry configured to communicatively couple the AU 410 to the I/O circuitry such that the I/O circuitry 412 is capable of routing signals to and from the AU 410 to one or more other components of the processing system 400. Further, the PCIe connectors 438 are configured to communicatively couple the I/O device 408 to the I/O circuitry 412 such that the I/O circuitry 412 is capable of routing signals to and from the I/O device 408 to one or more other components of the processing system 400.

By way of example and not limitation, the I/O device 408 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 408 is configured to execute one or more operations, tasks, instructions, or any combination thereof based on one or more physical registers 440 of the I/O device 408. In one or more implementations, such physical registers 440 are configured to maintain data (e.g., operands, instructions, values, variables) indicating one or more operations, tasks, or instructions to be performed by the I/O device 408.

To manage communication between components of the processing system 400 (e.g., AU 410, I/O device 408) that are connected to PCI connectors 438, and one or more other components of the processing system 400, the I/O circuitry 412 includes PCI switch 442. The PCI switch 442, for example, includes circuitry configured to route packets to and from the components of the processing system 400 connected to the PCI connectors 438 as well as to the other components of the processing system 400. As an example, based on address data indicated in a packet received from a first component (e.g., CPU 402), the PCI switch 442 routes the packet to a corresponding component (e.g., AU 410) connected to the PCI connectors 438.

Based on the processing system 400 executing a graphics application, for instance, the CPU 402, the AU 410, or both are configured to execute one or more instructions (e.g., draw calls) such that a scene including one or more graphics objects is rendered. After rendering such a scene, the processing system 400 stores the scene in the storage 414, displays the scene on the display 426, or both. The display 426, for example, includes a cathode-ray tube (CRT) display, liquid crystal display (LCD), light emitting diode (LED) display, organic light emitting diode (OLED) display, or any combination thereof. To enable the processing system 400 to display a scene on the display 426, the I/O circuitry 412 includes display circuitry 444. The display circuitry 444, for example, includes high-definition multimedia interface (HDMI) connectors, DisplayPort connectors, digital visual interface (DVI) connectors, USB connectors, and the like, each including circuitry configured to communicatively couple the display 426 to the I/O circuitry 412. Additionally or alternatively, the display circuitry 444 includes circuitry configured to manage the display of one or more scenes on the display 426 such as display controllers, buffers, memory, or any combination thereof.

Further, the CPU 402, the AU 410, or both are configured to concurrently run one or more virtual machines (VMs), which are each configured to execute one or more corresponding applications. To manage communications between such VMs and the underlying resources of the processing system 400, such as any one or more components of processing system 400, including the CPU 402, the I/O device 408, the AU 410, and the system memory 406, the I/O circuitry 412 includes memory management unit (MMU) 446 and input-output memory management unit (IOMMU) 448.

The MMU 446 includes, for example, circuitry configured to manage memory requests, such as from the CPU 402 to the system memory 406. For example, the MMU 446 is configured to handle memory requests issued from the CPU 402 and associated with a VM running on the CPU 402. These memory requests, for example, request access to read, write, fetch, or pre-fetch data residing at one or more virtual addresses (e.g., guest virtual addresses) each indicating one or more portions (e.g., physical memory addresses) of the system memory 406. Based on receiving a memory request from the CPU 402, the MMU 446 is configured to translate the virtual address indicated in the memory request to a physical address in the system memory 406 and to fulfill the request.

The IOMMU 448 includes, for example, circuitry configured to manage memory requests (memory-mapped I/O (MMIO) requests) from the CPU 402 to the I/O device 408, the AU 410, or both, and to manage memory requests (direct memory access (DMA) requests) from the I/O device 408 or the AU 410 to the system memory 406. For example, to access the registers 440 of the I/O device 408, the registers 436 of the AU 410, and/or the AU memory 434, the CPU 402 issues one or more MMIO requests. Such MMIO requests each request access to read, write, fetch, or pre-fetch data residing at one or more virtual addresses (e.g., guest virtual addresses) which each represent at least a portion of the registers 440 of the I/O device 408, the registers 436 of the AU 410, or the AU memory 434, respectively.

As another example, to access the system memory 406 without using the CPU 402, the I/O device 408, the AU 410, or both are configured to issue one or more DMA requests. Such DMA requests each request access to read, write, fetch, or pre-fetch data residing at one or more virtual addresses (e.g., device virtual addresses) which each represent at least a portion of the system memory 406. Based on receiving an MMIO request or DMA request, the IOMMU 448 is configured to translate the virtual address indicated in the MMIO or DMA request to a physical address and fulfill the request.

In variations, the processing system 400 can include any combination of the components depicted and described. For example, in at least one variation, the processing system 400 does not include one or more of the components depicted and described in relation to FIG. 4. Additionally or alternatively, in at least one variation, the processing system 400 includes additional and/or different components from those depicted. The 400 is configurable in a variety of ways with different combinations of components in accordance with the described techniques.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 102, the processor 104, the memory system 106 having the volatile memory 108 and the non-volatile memory 110, the execution units 112, the load-store units 114, the cache system 116, the behavior monitor 128, and the referee logic 206) are implemented in any of a variety of different manners such as hardware circuitry, software or firmware executing on a programmable processor, or any combination of two or more of hardware, software, and firmware. The methods provided are implemented in various devices, such as general-purpose computers, processors, or processor cores. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include read-only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A processor comprising:
a cache controller associated with a shared cache level of a hierarchy of one or more cache levels, the cache controller configured to penalize access requests from a first application to the shared cache level in response to detecting a suspicious access pattern of the access requests, the shared cache level accessible by multiple applications of the processor, including the first application and a second application.

2. The processor of claim 1, wherein the suspicious access pattern indicates a cache side-channel attack by the first application against the second application.

3. The processor of claim 2, wherein the suspicious access pattern includes a number of access requests by the first application to a cache index of multiple cache indices in the shared cache level within a time window, the number being greater than or equal to an access threshold.

4. The processor of claim 3, wherein the time window is a sliding time window.

5. The processor of claim 1, wherein the cache controller is further configured to obtain statistics on the access requests of each application having access to the shared cache level.

6. The processor of claim 1, wherein the cache controller is configured to penalize the access requests by sending subsequent access requests of the first application to memory located outside the hierarchy of one or more cache levels.

7. The processor of claim 1, wherein the cache controller is configured to penalize the access requests by introducing a delay in responses to subsequent access requests of the first application.

8. The processor of claim 7, wherein the delay is a variable and random amount for each response to the subsequent access requests of the first application.

9. The processor of claim 1, wherein the cache controller is configured to penalize the access requests for a set amount of time.

10. The processor of claim 9, wherein the set amount of time:
depends on a degree, a length, or a repetition of the suspicious access pattern by the first application; or
is longer than a colocation window for the first application and the second application in the shared cache level.

11. The processor of claim 1, wherein the cache controller is configured to penalize the access requests by temporarily partitioning a cache line of the shared cache level targeted by the access requests from other cache lines accessed by the second application.

12. The processor of claim 1, wherein the processor comprises a system on chip (SoC) with multiple processing cores.

13. A system comprising:
multiple processor cores, including a first application executing on a first processor core and a second application executing on a second processor core;
a shared cache level of a hierarchy of one or more cache levels accessible by the multiple processor cores; and
a cache controller associated with the shared cache level configured to penalize first access requests from the first application to the shared cache level in response to detecting a suspicious access pattern of the first access requests in relation to second access requests of the second application.

14. The system of claim 13, wherein the first application and the second application have access to the shared cache level for a first amount of time.

15. The system of claim 13, wherein the cache controller is configured to penalize the first access requests for a second amount of time, the second amount of time being equal to or greater than the first amount of time.

16. The system of claim 13, wherein the cache controller is further configured to maintain a record of suspicious access patterns by the first application.

17. The system of claim 13, wherein the cache controller is configured to penalize the first access requests by:
sending subsequent first access requests of the first application to memory located outside the hierarchy of one or more cache levels; or
introducing a delay in responses to the subsequent first access requests of the first application.

18. The system of claim 13, wherein the shared cache level is a level three cache.

19. The system of claim 13, wherein the suspicious access pattern includes a number of first access requests by the first application to a cache index of multiple cache indices in the shared cache level within a time window, the number being greater than or equal to an access threshold.

20. A method comprising:
monitoring, by a cache controller, access requests of an application of multiple applications to a shared cache level of a hierarchy of one or more cache levels; and
in response to detecting a suspicious access pattern of the access requests, penalizing, by the cache controller, subsequent access requests from the application to the shared cache level.
